(19) United States
(12) Patent Application Publication
(10) Pub. No.: US 2013/0251967 A1
(43) Pub. Date: Sep. 26, 2013

(54) SYSTEM, METHOD, AND COMPUTER PROGRAM PRODUCT FOR CONTROLLING WARPING OF A SUBSTRATE

(71) Applicants: Leilei Zhang, Sunnyvale, CA (US); Abraham F. Yee, Cupertino, CA (US); Zuhair Bokharey, Fremont, CA (US)

(72) Inventors: Leilei Zhang, Sunnyvale, CA (US); Abraham F. Yee, Cupertino, CA (US); Zuhair Bokharey, Fremont, CA (US)

(73) Assignee: NVIDIA CORPORATION, Santa Clara, CA (US)

(21) Appl. No.: 13/427,782

(22) Filed: Mar. 22, 2012

(51) Int. Cl. B32B 3/10; B23K 31/02

(52) U.S. Cl. 428/209; 228/173.6

(57) ABSTRACT

A system, method, and computer program product are provided for controlling warping of a substrate. In use, a first solder mask is attached to a top side of a substrate. Additionally, a second solder mask is attached to a bottom side of the substrate, wherein the first solder mask and the second solder mask control warping of the substrate.

### FIELD OF THE INVENTION

The present invention relates to constructing electronic circuits, and more particularly to constructing electronic circuits using a surface mount method.

### BACKGROUND

The construction of electronic circuits is commonly performed utilizing methods such as surface mount technology. However, current techniques for implementing surface mount technology with current components have been associated with various limitations.

For example, one or more substrates may be used when performing surface mount circuit construction. Additionally, there is an increasing demand for thinner electronic circuit construction, including the use of thinner substrates. However, thinner versions of current substrates may be more likely to warp during circuit construction.

There is thus a need for addressing these and/or other issues associated with the prior art.

### SUMMARY

A system, method, and computer program product are provided for controlling warping of a substrate. In use, a first solder mask is attached to a top side of a substrate. Additionally, a second solder mask is attached to a bottom side of the substrate, wherein the first solder mask and the second solder mask control warping of the substrate.

### BRIEF DESCRIPTION OF THE DRAWINGS

FIG. 1 shows a method for controlling warping of a substrate, in accordance with one embodiment.

FIG. 2 shows an exemplary substrate, in accordance with another embodiment.

FIG. 3 shows an exemplary substrate alteration, in accordance with yet another embodiment.

FIG. 4 illustrates an exemplary system in which the various architecture and/or functionality of the various previous embodiments may be implemented.

### DETAILED DESCRIPTION

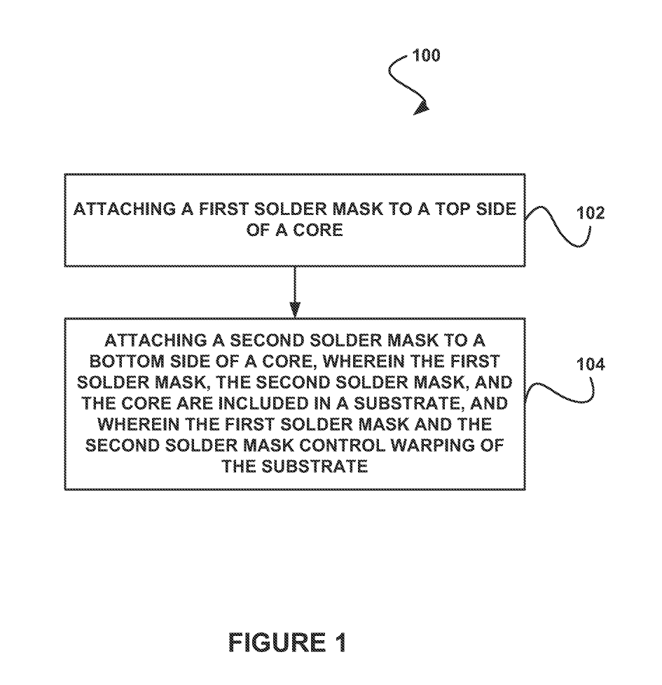

FIG. 1 shows a method 100 for controlling warping of a substrate, in accordance with one embodiment. As shown in operation 102, a first solder mask is attached to a top side of a substrate. In one embodiment, the substrate may include a core. For example, the core may include any material used as the center of a substrate. In another embodiment, the core may be made from a composite material. For example, the core may be made from fiberglass or another woven composite. In yet another embodiment, the core may be made from a metal. For example, the core may be made from aluminum. In another example, the core may be built up from copper. Of course, however, the core may be made from any material.

Additionally, in one embodiment, the solder mask may include any material that covers at least part of a side of the substrate. For example, the first solder mask may cover at least a portion of the top side of the substrate. In another embodiment, the solder mask may be made from a polymer material. For example, the solder mask may be made of epoxy. In yet another embodiment, the solder mask may be made of liquid photoimageable solder mask (LPSM) ink, dry photoimageable solder mask (DFSM), etc. Of course, however, the solder mask may be made of any material.

Further, in one embodiment attaching the solder mask to the side of the substrate may include silkscreening the solder mask onto the side of the substrate. In another embodiment, attaching the solder mask to the side of the substrate may include spraying the solder mask onto the side of the substrate. In yet another embodiment, attaching the solder mask to the side of the substrate may include laminating (e.g., vacuum laminating, etc.) the solder mask onto the side of the substrate.

In still another embodiment, attaching the solder mask to the side of the substrate may include curing the solder mask. For example, the solder mask may undergo a thermal cure after it has been applied to the side of the substrate. In another embodiment, attaching the solder mask to the side of the substrate may include applying the solder mask to the side of the substrate in layers.

Further still, as shown in operation 104, a second solder mask is attached to a bottom side of a substrate, wherein the first solder mask and the second solder mask contribute to warping of the substrate. In one embodiment, the substrate may include a circuit board for receiving one or more components (e.g., one or more silicon based integrated circuits such as a central processing unit (CPU), graphics processing unit (GPU), etc.). For example, the substrate may include a circuit board for receiving one or more integrated circuits (e.g., dies, etc.) through a surface mount process, a controlled collapse chip connection (flip chip) process, a hot air reflow process, etc. In another embodiment, the substrate may be positioned between the first solder mask and the second solder mask (e.g., such that the substrate is sandwiched between the first solder mask and the second solder mask).

Also, in one embodiment, the second solder mask may be attached to the bottom side of the substrate in the same manner as the first solder mask is attached to the top side of the substrate. In another embodiment, the top side of the substrate may include the side of the substrate at which one or more components are received during a mounting process. For example, the top side of the substrate may include the side of the substrate at which one or more components are attached during a surface mount process, a flip chip process, etc.

Further, in one embodiment, the first solder mask may be different from the second solder mask. For example, the first solder mask may have a different thermal coefficient than the second solder mask. For instance, the first solder mask may have a higher CTE than the second solder mask. In another embodiment, the first solder mask may have a different thickness than the second solder mask. For example, the first solder mask may have a greater thickness than the second solder mask. In another example, the first solder mask may have a larger number of layers than the second solder mask.

Further still, in one embodiment, the warping of the substrate may be controlled during the process of attaching one or more components to the substrate (e.g., utilizing a surface mount method, a flip chip mount method, etc.). For example, during the process of attaching one or more components to the substrate, a cooling process may occur, where such cooling process may include a period of decreased temperature after one or more components and the substrate are heated while one or more components are attached to the substrate utilizing a surface mount method, a flip chip method, etc.

In another embodiment, during the cooling process, the first solder mask may shrink to a different extent than the second solder mask, thereby resulting in solder mask warping. For example, the first solder mask may shrink (e.g., compress, condense, etc.) more than the second solder mask during the cooling process. In this way, the shrinking may cause solder mask warping, which may intentionally warp (e.g., bend, etc.) the substrate in a concave manner from a top-down viewpoint (e.g., the substrate may warp in a “smiling/happy face” manner when viewed from the side) during the cooling process.

In addition, in one embodiment, component-substrate warping may occur during the cooling process. For example, the component-substrate warping may occur during the cooling process as a result of a difference between a coefficient of thermal expansion (CTE) of the one or more components attached to the substrate and a CTE of the substrate. For instance, the substrate may have a higher CTE than the one or more components attached to the substrate, and the substrate may shrink (e.g., compress, condense, etc.) more than the one or more components during the cooling process. In another embodiment, component-substrate warping may warp the combination of the components and the substrate in a convex manner from a top-down viewpoint (e.g., the combination may warp in a “frowning/sad/crying face” manner when viewed from the side) during the cooling process.

Also, in one embodiment, warping of the substrate may be controlled by neutralizing the component-substrate warping through intentional solder mask warping during the cooling process. For example, by making the first solder mask different from the second solder mask, the resulting intentional concave solder mask warping may counteract the convex component-substrate warping, resulting in a straight (e.g., flat, etc.) substrate and components that have neither convex nor concave warping. In this way, substrates may be able to be made thinner (e.g., with a lower Z height, etc.), thereby allowing products with a lower profile, while still meeting package (e.g., component and substrate) warping requirements and specifications (e.g., industry standards, etc.).

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

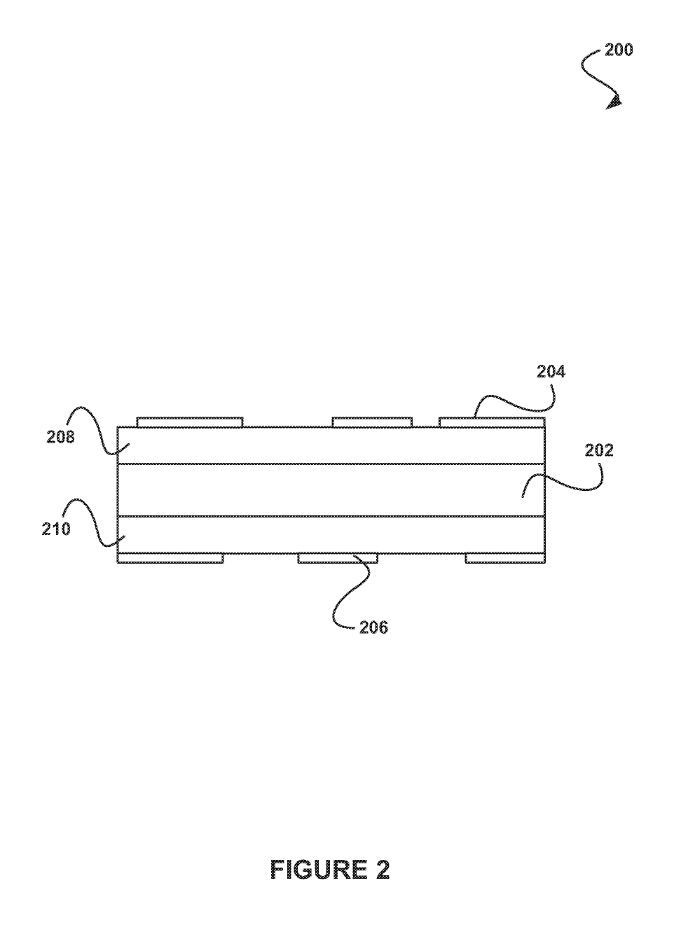

FIG. 2 shows an exemplary substrate 200, in accordance with another embodiment. As an option, the substrate 200 may be carried out in the context of the functionality of FIG. 1. Of course, however, the substrate 200 may be implemented in any desired environment. It should also be noted that the aforementioned definitions may apply during the present description.

As shown, the substrate 200 includes a core 202 in addition to a first solder mask 204 attached to the top of the core 202 and a second solder mask 206 attached to the bottom of the core 202. In one embodiment, the substrate 200 may include a flip chip substrate (e.g., a substrate used to receive one or more integrated circuit chips during a flip chip process, etc.).

Additionally, in one embodiment, the first solder mask 204 attached to the top of the core 202 may have a thickness greater than the second solder mask 206 attached to the bottom of the core 202. For example, the first solder mask 204 may be composed of the same material as the second solder mask 204, but the first solder mask 204 may have more layers of solder mask material than the second solder mask 204. In another embodiment, the first solder mask 204 attached to the top of the core 202 may be composed of a different material than the second solder mask 206 attached to the bottom of the core 202. For example, the first solder mask 204 may be composed of a material having a higher CTE than the second solder mask 204.

In this way, during a cooling process, the first solder mask 204 attached to the top of the core 202 may shrink more than the second solder mask 206 attached to the bottom of the core 202. Additionally, during the cooling process, the difference in shrinking between the first solder mask 204 and the second solder mask 206 may result in a warping of the substrate 200 in a concave manner.

Further, in one embodiment, the first solder mask 204 attached to the top of the core 202 may have a thickness smaller than the second solder mask 206 attached to the bottom of the core 202. For example, the first solder mask 204 may be composed of the same material as the second solder mask 204, but the first solder mask 204 may have fewer layers of solder mask material than the second solder mask 204. In another embodiment, the first solder mask 204 may be composed of a material having a lower CTE than the second solder mask 204. In this way, during a cooling process, the first solder mask 204 attached to the top of the core 202 may shrink less than the second solder mask 206 attached to the bottom of the core 202. Additionally, during the cooling process, the difference in shrinking between the first solder mask 204 and the second solder mask 206 may result in a warping of the substrate 200 in a convex manner.

Further still, the substrate 200 includes a top amount of build up material 208 and a bottom amount of build up material 210. In one embodiment, the top amount of build up material 208 may be greater than bottom amount of build up material 210, such that during the cooling process, the substrate 200 may warp in a particular (e.g., convex or concave) first manner. In another embodiment, the top amount of build up material 208 may be less than bottom amount of build up material 210, such that during the cooling process, the substrate 200 may warp in a particular (e.g., convex or concave) second manner opposite the first manner.

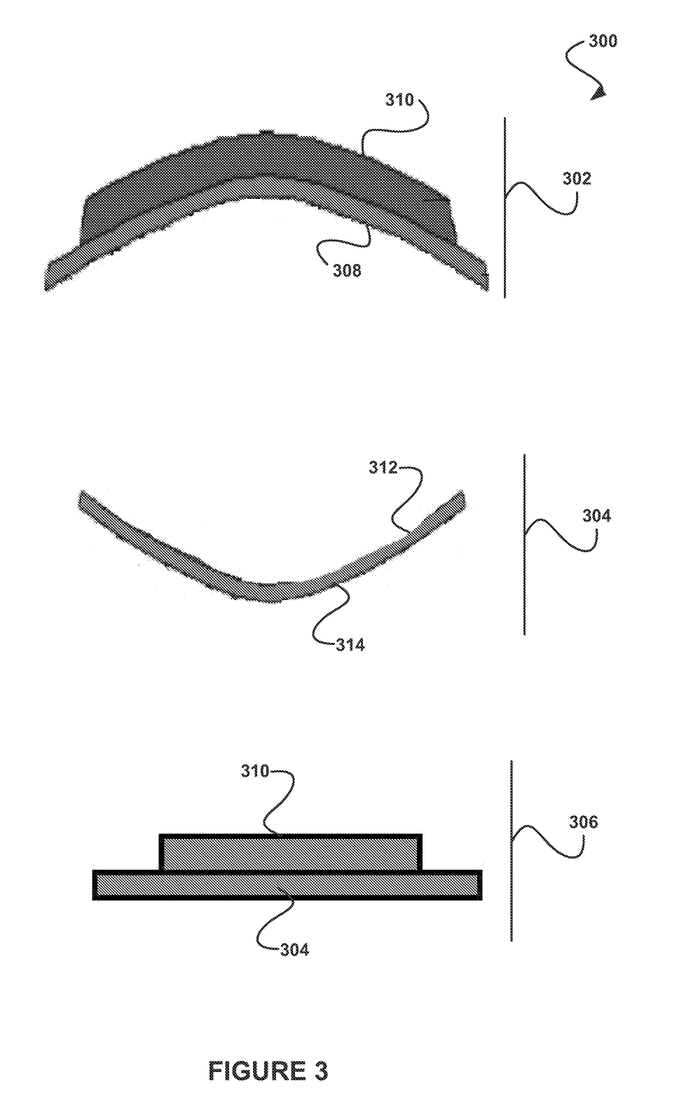

FIG. 3 shows an exemplary substrate alteration 300, in accordance with another embodiment. As an option, the present substrate assembly 300 may be carried out in the context of the functionality of FIGS. 1 and 2. Of course, however, the substrate assembly 300 may be implemented in any desired environment. It should also be noted that the aforementioned definitions may apply during the present description.

As shown, an unaltered substrate 308 of an unaltered component-substrate package 302 is substituted with an altered substrate 304 to create an altered component-substrate package 306. The unaltered component-substrate package 302 includes the unaltered substrate 308 and a component 310. In one embodiment, the component 310 may include a die that is mounted to the unaltered substrate 308. In another embodiment, the component 310 may have a lower CTE than the unaltered substrate 308, such that when the unaltered component-substrate package 302 is heated and then cooled during mounting of the component 310 to the unaltered substrate 308, the unaltered substrate 308 shrinks more than the component 310, resulting in the warping of the unaltered component-substrate package 302 in a convex manner.

Additionally, the altered substrate 304 includes a top solder mask 312 and a bottom solder mask 314. In one embodiment, the top solder mask 312 may have a lower CTE than the bottom solder mask 314, such that when the altered substrate 304 is heated and then cooled, the top solder mask 312 shrinks more than the bottom solder mask 314, resulting in the warping of the altered substrate 304 in a concave manner.

Further, the altered component-substrate package 306 includes the altered substrate 304 to which the component 310 is mounted. As a result, when altered component-substrate package 306 is heated and then cooled during mounting of the component 310 to the altered substrate 304, the convex warping of the unaltered substrate 308 is counteracted, and therefore neutralized, by the concave warping of the altered substrate 304, thereby resulting in a flat altered substrate 304 and component 310 that are not warped. In this way, the altered component-substrate package 306 may meet one or more package warpage requirements not met by the unaltered component-substrate package 302.

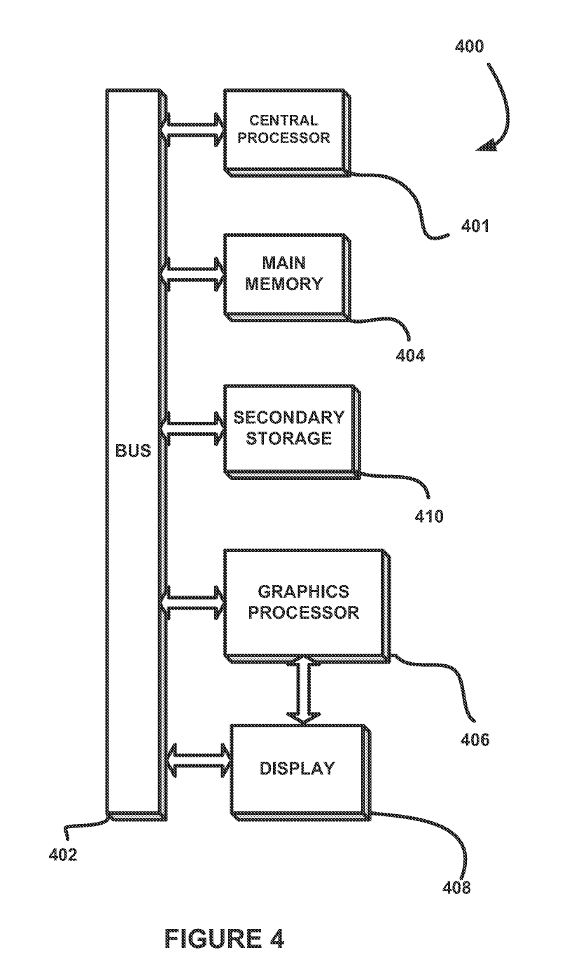

FIG. 4 illustrates an exemplary system 400 in which the various architecture and/or functionality of the various previous embodiments may be implemented. As shown, a system 400 is provided including at least one host processor 401 which is connected to a communication bus 402. The system 400 also includes a main memory 404. Control logic (software) and data are stored in the main memory 404 which may take the form of random access memory (RAM).

The system 400 also includes a graphics processor 406 and a display 408, i.e. a computer monitor. In one embodiment, the graphics processor 406 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 400 may also include a secondary storage 410. The secondary storage 410 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 404 and/or the secondary storage 410. Such computer programs, when executed, enable the system 400 to perform various functions. Memory 404, storage 410 and/or any other storage are possible examples of computer-readable media.

In one embodiment, the architecture and/or functionality of the various previous figures may be implemented in the context of the host processor 401, graphics processor 406, an integrated circuit (not shown) that is capable of at least a portion of the capabilities of both the host processor 401 and the graphics processor 406, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 400 may take the form of a desktop computer, laptop computer, and/or any other type of logic. Still yet, the system 400 may take the form of various other devices m including, but not limited to a personal digital assistant (PDA) device, a mobile phone device, a television, etc.

Further, while not shown, the system 400 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
attaching a first solder mask to a top side of a substrate; and
attaching a second solder mask to a bottom side of the substrate;
wherein the first solder mask and the second solder mask contribute to a warping of the substrate.

2. The method of claim 1, wherein the first solder mask covers at least a portion of the top side of the substrate.

3. The method of claim 1, wherein attaching the first solder mask to the top side of the substrate includes laminating the solder mask onto the top side of the substrate.

4. The method of claim 1, wherein the substrate includes a circuit board for receiving one or more components.

5. The method of claim 1, wherein the one or more components include one or more silicon based integrated circuits.

6. The method of claim 1, wherein the one or more components include one or more of a central processing unit (CPU) and a graphics processing unit (GPU).

7. The method of claim 1, wherein the substrate includes a circuit board for receiving one or more integrated circuits through a surface mount process.

8. The method of claim 1, wherein the first solder mask is different from the second solder mask.

9. The method of claim 8, wherein the first solder mask has a different thermal coefficient than the second solder mask.

10. The method of claim 8, wherein the first solder mask has a different thickness than the second solder mask.

11. The method of claim 1, wherein the warping of the substrate is controlled during a process of attaching one or more components to the substrate.

12. The method of claim 1, wherein during a cooling process, the first solder mask shrinks to a different extent than the second solder mask.

13. The method of claim 12, wherein the first solder mask shrinks more than the second solder mask during the cooling process.

14. The method of claim 13, wherein the shrinking causes solder mask warping, which intentionally warps the substrate in a concave manner.

15. The method of claim 14, wherein component-substrate warping occurs during the cooling process as a result of a difference between a coefficient of thermal expansion (CTE) of one or more components attached to the substrate and a CTE of the substrate.

16. The method of claim 15, wherein the substrate has a higher CTE than the one or more components attached to the substrate, and the substrate shrinks more than the one or more components during the cooling process.

17. The method of claim 15, wherein component-substrate warping warps a combination of the components and the substrate in a convex manner.

18. The method of claim 17, wherein the warping of the substrate is controlled by neutralizing the component-substrate warping through the solder mask warping during the cooling process.

19. The method of claim 18, wherein the solder mask warping counteracts the component-substrate warping, resulting in a flat substrate and components that have neither convex nor concave warping.

20. A substrate, comprising:
a first solder mask attached to a top side of the substrate; and
a second solder mask attached to a bottom side of the substrate;
wherein the first solder mask and the second solder mask control warping of the substrate.
